(19) United States
(12) Patent Application Publication
(10) Pub. No.: US 2012/0156573 A1
(43) Pub. Date: Jun. 21, 2012

(54) FUEL CELL WITH MONOLITHIC ELECTROLYTES MEMBRANE ASSEMBLY

(75) Inventors: Alain THOREL, Saint-Vrain (FR); Zdravko STOYNOV, Sofia (BG); Daria VLADIKOVA, Sofia (BG); Anthony CHESNAUD, Pontault-Combault (FR); Massimo VIVIANI, Campomorone (IT); Sabrina PRESTO, Genova (IT)

(73) Assignee: ASSOCIATION POUR LA RECHERCHE ET LE DEVELOPPEMENT DES METHODES ET PROCESSUS INDUSTRIELS <<ARMINES>>, Paris (FR)

(21) Appl. No.: 13/326,950

(22) Filed: Dec. 15, 2011

(30) Foreign Application Priority Data
Dec. 17, 2010 (FR) 1060705

(51) Int. Cl. H01M 8/10; H01M 8/00; H01M 8/06

(52) U.S. Cl. 429/409; 429/482

(57) ABSTRACT

The invention relates to a fuel cell (1) comprising
an anode (10) capable of oxidizing a first compound M1 into first ions M^{(m+)} with m being a non-zero integer,
a first electrolyte (20) which is capable of conducting these first ions M^{(m+)}, and which is in contact with said anode (10),
a cathode (50) capable of reducing a second compound N2 into second ions N⁽ⁿ⁻⁾ with n being a non-zero integer,
a second electrolyte (40) which is capable of conducting the second ions N⁽ⁿ⁻⁾, and which is in contact with said cathode (50),
a porous central membrane (30), one of the faces of which is in contact with said first electrolyte (20) and the opposite face of which is in contact with said second electrolyte (40).

The first electrolyte (20), the second electrolyte (40), and the central membrane (30) consist of the same material which is capable of both conducting M^{(m+)} ions and N⁽ⁿ⁻⁾ ions.

The present invention relates to a fuel cell comprising an anode capable of oxidizing a first compound M1 into first ions M^{(m+)} with m being a non-zero integer, a first electrolyte which is capable of conducting these first ions M^{(m+)}, and which is in contact with this anode, a cathode capable of reducing a second compound N2 into second ions N⁽ⁿ⁻⁾ with n being a non-zero integer, a second electrolyte which is capable of conducting these second ions N⁽ⁿ⁻⁾, and which is in contact with this cathode, a porous central membrane, one of the faces of which is in contact with the first electrolyte, and the opposite face of which is in contact with the second electrolyte.

Fuel cells (FC) are intended to become an source for producing energy, an alternative to those directly stemming from fossil resources, for stationary applications, but also for on-board applications (for example automobiles) in the longer term.

An FC operates on the principle of electrochemical and controlled oxidation-reduction of a first compound M1 and of a second compound N2, with simultaneous production of electricity, of the compound P and of heat, according to the global chemical reaction

{nM1+mN2→pP}

with n, m and p being non-zero integers.

M1 designates a compound of identical or distinct atoms which, upon oxidation, gives a first ion M^{(m+)} (or m first ions M⁺) and m electrons.

N2 designates a compound of identical or distinct atoms which, by reduction in the presence of n electrons, gives a second ion N⁽ⁿ⁻⁾ (or n second ions N⁻).

It is this produced electricity which may then power a device.

For example, the FC is such that the first compound M1 is hydrogen (H₂) and the second compound N2 is oxygen (O₂), and the overall chemical reaction is

{H₂+½O₂→H₂O}.

The compound produced from this reaction is water H₂O.

The example of such an FC is considered below.

The inventors have already developed an FC with mixed anion and proton conduction (patent application WO 2006/097663) illustrated in FIG. 2, and the operation of which is recalled hereafter.

This FC 1 comprises five main layers which are in contact pairwise and the stacking of which is in this order:
An anode 10,
A first electrolyte 20,
A central membrane 30,
A second electrolyte 40,
A cathode 50.

The anode 10 is the seat of an oxidation reaction of hydrogen:

{H₂→2H⁺+2e⁻}.

The thereby generated protons H⁺ migrate towards the central membrane 30 through the first electrolyte 20. This first electrolyte 20 is therefore a material capable of conducting protons H⁺.

The produced electrons e⁻ circulate through the outside of the FC from the anode 10 through a conductor 90 in order to return to the cathode 50 and supply it with electrons (see below).

The cathode C is the seat of a reduction reaction of oxygen:

{½O₂+2e⁻→O²⁻}

The thereby generated ions O²⁻ migrate towards the central membrane 30 through the second electrolyte 40. This second electrolyte 40 is therefore a material capable of conducting the O²⁻ ions.

Thus, a first face of the central membrane 30 is in contact with the first electrolyte 20 and a second face of the central membrane 30, opposite to this first face, is in contact with the second electrolyte 40.

The central membrane 30 is a composite of the first electrolyte 20 and of the second electrolyte 40, so as to be able to conduct both protons H⁺ and ions O²⁻.

Inside this central membrane 30, these protons H⁺ and these ions O²⁻ react according to the following reaction in order to produce water:

{2H⁺+O²⁻→H₂O}

This central membrane 30 is further porous with porosities 35, in order to allow better discharge of the thereby produced water.

Such an FC as compared with FCs with simple conduction has the advantage of discharging water at the central membrane 30 and not at the electrodes (anode and cathode): indeed, when water is discharged at the anode or at the cathode, the water neutralizes the active sites (sites for oxidation of the hydrogen or reduction of the oxygen) in these electrodes.

However, this FC, and in general an FC operating by oxidation-reduction of a first compound M1 and of a second compound N2, has drawbacks:

On the one hand, the manufacturing of the central membrane 30, generally by sintering, is complex because of physico-chemical and thermomechanical incompatibilities (different thermal expansion coefficients) between the material of the first electrolyte 20 and the material of the second electrolyte 40, and because of the difference in the sintering temperature between both of these materials.

On the other hand, these incompatibilities cause premature ageing of the central membrane 30 with deformation and/or cracking of the central membrane 30, and/or obturations of its porosity network. The result of this is a significant reduction in the performances of the FC.

The present invention aims at finding a remedy to these drawbacks.

The invention aims at proposing a fuel cell, the manufacturing of which is facilitated, and the operating efficiency of which is improved, and the service life of which is increased.

This goal is achieved by the fact that the first electrolyte, the second electrolyte and the central membrane consist of the same material which is capable of conducting both M^{(m+)} ions and N⁽ⁿ⁻⁾ ions.

By these arrangements, the manufacturing of the fuel cell is greatly simplified, since the assembly consisting of the first electrolyte, of the central membrane and of the second electrolyte may be manufactured in a single operation, for example by sintering. The mechanical strength and the life-time of this assembly are also improved.

Further, the surface area of the possible reaction sites within the central membrane is strongly increased. Indeed, in an FC according to the prior art, the reaction sites between the first ions (for example protons H⁺) and the second ions (for example ions O²⁻) within the central membrane are limited to the common interfaces between the material of the first electrolyte, the material of the second electrolyte, and the porosities, i.e. these reaction sites are one-dimensional (a plurality of curves in space). On the other hand, in an FC according to the invention, the possible reaction sites are formed by the free surfaces of the material of the central membrane (i.e. the interface between this material and the porosities). The reaction sites are therefore two-dimensional (a plurality of surfaces in space), i.e. much more numerous. Simultaneously, the internal resistance of the central membrane is reduced since the latter has the same ion conductivity in every point, i.e. the ion conductivity of the material making it up (whereas in the prior art the ion conductivity varies in the space between that of the first electrolyte and that of the second electrolyte, which makes the ion circulation paths more twisted, and therefore increases the internal resistance of the central membrane).

The invention will be better understood and its advantages will become better apparent, upon reading the detailed description which follows of an embodiment illustrated as a non-limiting example. The description refers to the appended drawings wherein:

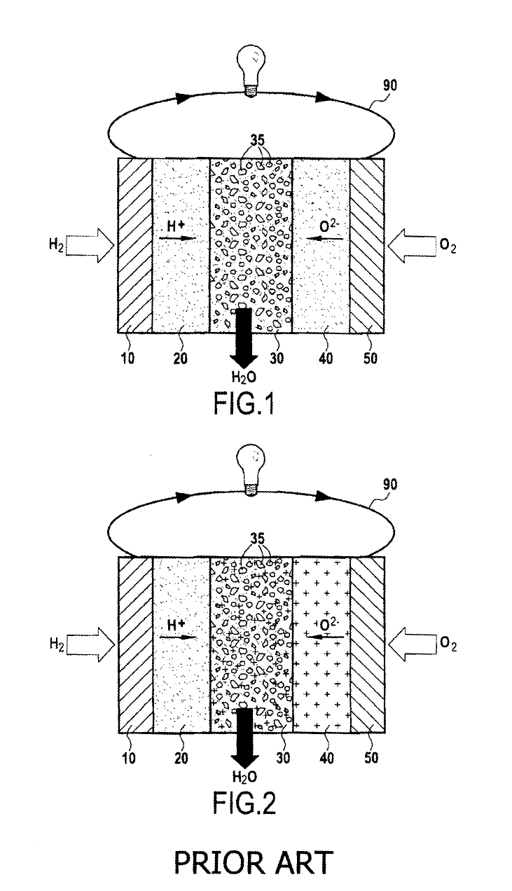

FIG. 1 is a schematic illustration of a fuel cell according to the invention.

FIG. 2 is a schematic illustration of a fuel cell according to the prior art.

FIG. 1 illustrates a fuel cell (FC) according to the invention.

This FC1 comprises five main layers which are in contact pairwise and the stacking of which is in this order:
An anode 10,
A first electrolyte 20,
A central membrane 30,
A second electrolyte 40,
A cathode 50.

In the description below, an FC is considered where the first compound M1 is hydrogen (H₂) and the second compound N2 is oxygen (O₂). However the invention also applies to reactions where the first compound is not hydrogen and/or the second compound is not oxygen.

The anode 10 is the seat of the oxidation reaction of hydrogen:

{H₂→2H⁺+2e⁻}.

The cathode 50 is the seat of the reduction reaction of oxygen:

{½O₂+2e⁻→O²⁻}

The first electrolyte 20, the second electrolyte 40 and the central membrane 30 each consists of a material capable of conducting protons H⁺ and capable of conducting ions O²⁻.

The produced electrons e⁻ circulate through the outside of the FC from the anode 10 through a conductor 90 in order to return to the cathode 50 and supply it with electrons.

Thus a first face of the central membrane 30 is in contact with the first electrolyte 20, and a second face of the central membrane 30, opposite to this first face, is in contact with the second electrolyte 40.

This central membrane 30 is further porous with porosities 35, in order to allow better discharge of the water thereby produced in the reaction

{2H⁺+O²⁻→H₂O}

In the case of an FC operating on the basis of a reaction different from the latter, it is the compound P, product of this different reaction, which is advantageously discharged through the porosities 35.

The assembly formed by the first electrolyte 20, the second electrolyte 40 and the central membrane 30 is therefore a block of the same material, the central membrane 30 additionally having porosities 35, while the electrolytes are dense. This assembly is therefore monolithic.

For example, this material is a ceramic, which has the advantage in that its porosity is controlled during the manufacturing of the FC, for example by sintering.

The tests conducted by the inventors have unexpectedly shown that the simultaneous mixed conduction of protons H⁺ and of ions O²⁻ within the central membrane 30 is not erratic, but on the contrary occurs efficiently.

In particular, the inventors have shown that such a ceramic with mixed conduction which may be used as a material for the FC is for example a barium cerate of formula BaCe_{0.85}Y_{0.15}O_{3-δ} with δ positive, small compared to 1.

This material is designated by BCY15 and has good conduction both of protons H⁺ and of ions O²⁻.

Advantageously, the operation of the FC is performed at a temperature comprised between 500° C. and 800° C.

Indeed, the inventors have shown that the yield of the FC was greater in this range of temperatures.

The inventors have made an FC according to the invention comprising several layers by combination of the following methods:
Forming and assembling the first electrolyte 20, the second electrolyte 40 and the central membrane 30 by cold compression and sintering of the material making up these layers,
Attaching the anode 10 onto the first electrolyte 20 and the cathode 50 onto the second electrolyte 40 by a deposition method, for example screen printing or tape casting,
Densifying the first electrolyte 20 and the second electrolyte 40 during sintering,
Adjusting the porosity of the central membrane 30.

With this manufacturing method it is possible to facilitate the manufacturing of an FC according to the invention.

The densification of the first electrolyte 20 and of the second electrolyte 40 may be achieved by adding a densification agent such as ZnO or CuO during sintering.

The porosity of the central membrane 30 may be achieved and/or adjusted by adding additives promoting the formation of pores during the sintering, and/or by a lower sintering temperature.

The anode 10 and the cathode 50 are for example a ceramic or a cermet (a ceramic-metal composite) which are manufactured according to known methods.

For example, the composition of an FC, where the notation {anode/1^{st} electrolyte/central membrane/2^{nd} electrolyte/cathode} is used, is one of the following:
BCY15-Ni/dense BCY15/porous BCY/dense BCY15/BCY15-LSCF or
BCY15-Ni/dense BCY15/porous BCY/dense BCY15/BCY15-Ag

wherein LSCF designates the ceramic of formula La₁₋ₓSrₓCo_{1-y}Fe_{y}O_{3-δ} with X and Y comprised between 0 and 1, and δ positive small compared with 1.

Advantageously, before attaching the anode 10 onto one face of the electrolyte 20 and the cathode 50 onto one face of the second electrolyte 40, a layer of porous material is deposited on these faces which is used for adhering to the anode 10 and to the cathode 50.

In the general case of an FC operating according to the principle of electrochemical and controlled oxidation-reduction of a first compound (M1) and of a second compound (N2), the above conclusions are applicable, the same material being used as a first electrolyte, second electrolyte and central membrane being capable of conducting both M^{(m+)} ions and N⁽ⁿ⁻⁾ ions.

This material is for example a ceramic.

1. A fuel cell comprising
an anode capable of oxidizing a first compound M1 into first ions M^{(m+)} with m being a non-zero integer,
a first electrolyte which is capable of conducting these first ions M^{(m+)}, and which is in contact with said anode,
a cathode capable of reducing a second compound N2 into second N⁽ⁿ⁻⁾ ions with n being a non-zero integer,
a second electrolyte which is capable of conducting these second ions
N⁽ⁿ⁻⁾, and which is in contact with said cathode,
a porous central membrane, one of the faces of which is in contact with said first electrolyte, and the opposite face of which is in contact with said second electrolyte,
said fuel cell being characterized in that said first electrolyte, said second electrolyte and said central membrane consist of the same material which is capable of conducting both M^{(m+)} ions and N⁽ⁿ⁻⁾ ions.

2. The fuel cell according to claim 1, characterized in that said first compound M1 is hydrogen H₂ which is oxidized into H⁺ ions, and the second compound N2 is oxygen O₂ which is reduced into O²⁻ ions.

3. The fuel cell according to claim 1, characterized in that said material making up said central membrane is a ceramic.

4. The fuel cell according to claim 2 characterized in that said ceramic is a barium cerate of formula BaCe_{0.85}Y_{0.15}O_{3-δ} with δ positive, small compared with 1.

5. The fuel cell according to claim 2 characterized in that its operation is performed at a temperature comprised between 500° C. and 800° C.

6. A method for manufacturing a fuel cell according to any of the preceding claims characterized in that it comprises the following steps:
Forming and assembling said first electrolyte, said second electrolyte and said central membrane by hot compression and sintering of the material making up these layers,
Attaching the anode onto said first electrolyte and the cathode onto said second electrolyte by a deposition method,
Densifying said first electrolyte and said second electrolyte during sintering,
Adjusting the porosity of said central membrane.

7. The method for manufacturing a fuel cell according to claim 6, characterized in that the adjustment of the porosity of said central membrane is achieved by addition of additives promoting the formation of pores during sintering, and/or by a lower sintering temperature.

8. The method for manufacturing a fuel cell according to claim 6, characterized in that before attaching said anode onto one face of said first electrolyte and said cathode onto one face of said second electrolyte, a layer of porous material is deposited on these faces, which is used for adhering to said anode and to said cathode.
